(19) United States
(12) Patent Application Publication
(10) Pub. No.: US 2022/0139069 A1
(43) Pub. Date: May 5, 2022

(54) INFORMATION PROCESSING SYSTEM, INFORMATION PROCESSING METHOD, AND RECORDING MEDIUM

(71) Applicant: NEC Corporation, Minato-ku, Tokyo (JP)

(72) Inventor: Takahiro TOIZUMI, Tokyo (JP)

(73) Assignee: NEC Corporation, Minato-ku, Tokyo (JP)

(21) Appl. No.: 17/435,512

(22) PCT Filed: Feb. 10, 2020
(86) PCT No.: PCT/JP2020/005178

§ 371 Date: Sep. 1, 2021

(30) Foreign Application Priority Data
Mar. 4, 2019 (JP) 2019-038366

(51) Int. Cl. G06V 10/771; G06V 10/74; G06V 10/774; G06N 20/00

(52) U.S. Cl. CPC G06V 10/771; G06N 20/00; G06V 10/774; G06V 10/761

(57) ABSTRACT

The information processing system according to the present invention includes: a first selection unit for selecting two or more images from a first data set that includes learning data including an image, a label associated with the image, and auxiliary information; a second selection unit for selecting an image from a second data set including learning data different from the learning data included in the first data set, based on positions in a feature space of the two or more images selected by the first selection unit; and a learning unit for learning a model for estimating a label based on the auxiliary information using the learning data included in the first data set and the learning data corresponding to the image selected by the second selection unit.

### TECHNICAL FIELD

The present invention relates to an information processing system, an information processing method, and a recording medium.

### BACKGROUND ART

Zero-shot recognition is a recognition technique that recognizes objects whose image examples do not exist in learning data. Test data in the zero-shot recognition include an unknown image, which is an image of an object whose image examples do not exist in the learning data. The zero-shot recognition estimates labels indicating the contents of unknown images included in the test data by utilizing auxiliary information about the object to be recognized.

Zero-shot recognition is described, for example, in Non-Patent Document 1. In Non-Patent Document 1, distributed representation of words is used as the auxiliary information.

### PRECEDING TECHNICAL REFERENCES

### Non-Patent Document

Non-Patent Document 1: A. Frome, G. S. Corrado, J. Shlens, S. Bengio, J. Dean, M. A. Ranzato, and T. Mikolov, “DeViSE: A Deep Visual-Semantic Embedding Model,” In NIPS, 2013.

### SUMMARY OF INVENTION

### Problem to be Solved by the Invention

Zero-shot recognition has a problem that the accuracy of recognition of unknown images cannot be sufficiently obtained. The reason is that there are few image data similar to the unknown image data in the learning data. An information processing system that can solve the above problem and generate a model to estimate labels of images with high accuracy is required.

It is an example object of the present invention to provide an information processing system, an information processing method and an information processing program for solving the problem described above.

### Means for Solving the Problem

An information processing system according to the present invention includes: a first selection means for selecting two or more images from a first data set that includes learning data including an image, a label associated with the image, and auxiliary information; a second selection means for selecting an image from a second data set including learning data different from the learning data included in the first data set, based on positions in a feature space of the two or more images selected by the first selection means; and a learning means for learning a model for estimating a label based on the auxiliary information using the learning data included in the first data set and the learning data corresponding to the image selected by the second selection means.

An information processing method according to the present invention includes: selecting two or more images from a first data set that includes learning data including an image, a label associated with the image, and auxiliary information; selecting an image from a second data set including the learning data different from the learning data included in the first data set, based on positions in a feature space of the two or more images selected from the first data set; and learning a model for estimating a label based on the auxiliary information using the learning data included in the first data set and the learning data corresponding to the image selected from the second data set.

A recording medium according to the present invention stores a program for causing a computer to execute: a first selection process for selecting two or more images from a first data set that includes learning data including an image, a label associated with the image, and auxiliary information; a second selection process for selecting an image from a second data set including learning data different from the learning data included in the first data set, based on positions in a feature space of the two or more images selected by the first selection process; and a learning process for learning a model for estimating a label based on the auxiliary information using the learning data included in the first data set and the learning data corresponding to the image selected by the second selection process.

An object of the present invention is also achieved by a computer-readable recording medium in which the above-described program is stored.

### Effect of the Invention

According to the present invention, it is possible to generate a model for estimating labels of images with high accuracy.

### BRIEF DESCRIPTION OF THE DRAWINGS

FIG. 1 is a block diagram illustrating an information processing system according to a first example embodiment.

FIG. 2 is a flowchart illustrating a flow of processing executed by the information processing system of the first example embodiment.

FIG. 3 is a diagram illustrating an example of a distribution of feature amounts of images of the first data set of the first example embodiment.

FIG. 4 is a diagram illustrating an example of a data set used for learning the first example embodiment.

FIG. 5 is a diagram illustrating an example of learning data and test data when the first example embodiment is not applied.

FIG. 6 is a diagram illustrating an example of learning data and test data when the first example embodiment is applied.

FIG. 7 is a block diagram illustrating an information processing system according to a second example embodiment.

FIG. 8 is a flowchart illustrating a flow of processing executed by the information processing system of the second example embodiment.

FIG. 9 is a diagram illustrating an example of a distribution of representative values calculated from the first data set of the second example embodiment.

FIG. 10 is a diagram illustrating an example of learning data selected from the second data set of the second example embodiment and used for learning.

FIG. 11 is a block diagram illustrating an information processing system according to a third example embodiment.

FIG. 12 is a flowchart illustrating a flow of processing executed by the information processing system of the third example embodiment.

FIG. 13 is an explanatory diagram illustrating a hardware configuration example of an information processing system according to the example embodiments.

### EXAMPLE EMBODIMENTS

Hereinafter, description of the example embodiments of the present invention will be given using the drawings. In all the drawings, like components are denoted by like reference numerals, and the description is omitted as appropriate. Unless otherwise noted, each block diagram represents the configuration of the functional unit rather than the configuration of the hardware unit.

### First Example Embodiment

### [Description of Configuration]

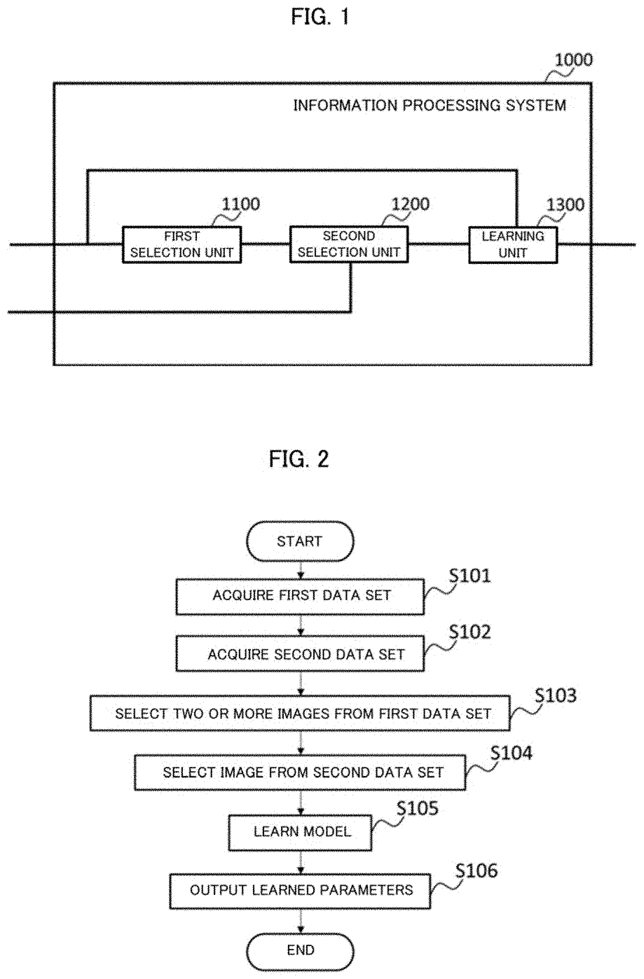

FIG. 1 is a diagram illustrating an example of functional blocks of the information processing system 1000 according to the first example embodiment. The information processing system 1000 according to the first example embodiment includes a first selection unit 1100, a second selection unit 1200, and a learning unit 1300.

The first selection unit 1100 acquires a first data set including learning data. The learning data included in the first data set includes an image, a label, and auxiliary information. The label and the auxiliary information are associated with the image.

The label is information indicating a correct answer of the learning data including the label. The label is a word or a sentence that indicates the correct answer of the object represented in the associated image. The images associated with the same label belong to the same class. The class is a category that classifies objects. The classes may have a hierarchical structure including a lower class and an upper class. For example, the images of dalmatians may be classified into the class of “dalmatian,” which is a word indicated by the label, and the class of “dogs,” which is an upper class of dalmatians.

The auxiliary information is the information used supplementally in estimating the label of the object to be recognized. For example, the auxiliary information may be distributed representation (word embedding) of words, an attribute, a dictionary definition sentence, an image explanatory sentence, visual line information, or the like. The distributed representation of words is information that can be generated from the word indicated by the label. Specifically, the distributed representation of a word is generated using a large amount of text corpus based on the distribution hypothesis that words appearing in the same context tend to have similar meanings. The attribute is information representing the characteristics of the object indicated by the image. For example, the attributes are information such as “fluffy”, “yellow”, and “four feet”. The dictionary definition sentence is information including a sentence describing a concept meant by a word indicated by a label using another word. The image explanatory sentence is information including sentences writing down the scene indicated by the image in natural language. The visual line information is the information indicating the movement of the visual line of a person who sees the image.

The first selection unit 1100 selects the images from the acquired first data set. For example, the first selection unit 1100 may randomly select two or more images from the first data set. Alternatively, the first selection unit 1100 may select two or more images to which labels of different classes are associated. For example, the first selection unit 1100 may arbitrarily select one image from each class of the learning data.

The first selection unit 1100 outputs the selected images.

The second selection unit 1200 acquires the images selected by the first selection unit 1100, and a second data set including learning data that is different from the learning data included in the first data set.

The learning data included in the second data set includes an image, a label, and auxiliary information. The label and the auxiliary information are associated with the image.

The second selection unit 1200 selects the images from the second data set based on the images selected by the first selection unit 1100. Specifically, the second selection unit 1200 selects the images corresponding to the middle of the positions in the feature space of the two or more images selected by the first selection unit 1100, from the second data set. The second selection unit 1200 extracts the feature amounts from the two or more images selected by the first selection unit 1100 and the images included in the second data set. For example, the second selection unit 1100 can convert the image into the feature amount using a learned neural network.

The second selection unit 1200 calculates the weighted mean X_{new} of the feature amounts extracted from the two or more images selected by the first selection unit 1100 using the Equation (1).

x_{new}=Σᵢ₌₁ⁿ(wᵢ*xᵢ) (1)

Here, “wᵢ” in Equation (1) is a weight. “xᵢ” is the feature amount of the image. “n” is an integer of two or more. Note that xᵢ is not limited to the feature amount of the image, and xᵢ may be a pixel value or the like of the image.

When two images are selected by the first selection unit 1100, the weighted mean X_{new} is calculated using the following Equation (2).

x_{new}=wᵢ*xᵢ+wⱼ*xⱼ (2)

In the Equation (2), “wᵢ”, “wⱼ” are weights, and “xᵢ”, “xⱼ” are the feature amounts of the images.

The weights used to calculate the weighted mean may be constants. For example, the weights may be the constants (wᵢ, wⱼ)=(0.4, 0.6). Alternatively, the weights may be values generated using random numbers. For example, in the generation of the weights using random numbers, by using a beta distribution having a condition of α=β as a distribution of random number generation, weighting is performed using a distribution symmetric with two data. In the generation of the weights using random numbers, by moving the value “α” as a hyperparameter, it is possible to express from a uniform distribution to a distribution choosing only one of them.

The second selection unit 1200 determines the similarity between the weighted mean X_{new} and the feature amounts of the images of the second data set. Then, the second selection unit 1200 selects images of the feature amount whose similarity degree is equal to or higher than a threshold value, from the second data set.

For example, the second selection unit 1200 uses cosine similarity to determine the similarity between the weighted mean X_{new} and the feature amounts of the images of the second data set. The following is an explanation where the weighted mean X_{new} and the feature amounts of the images of the second data set are vectors. The second selection unit 1200 normalizes the two vectors such that the lengths of the two vectors become “1”, and obtains the inner product between the normalized vectors. The second selection unit 1200 determines that the weighted mean X_{new} and the feature amount of the image of the second data set are similar when the obtained inner product is equal to or greater than a predetermined value. The similarity determination is not limited to cosine similarity, and Euclidean distance, Mahalanobis distance, KL divergence, Earth mover's distance, or the like may be used.

The second selection unit 1200 outputs the learning data corresponding to the images selected from the second data set.

The learning unit 1300 acquires the learning data of the first data set, and the learning data of the second data set corresponding to the images selected by the second selection unit 1200.

The learning unit 1300 learns the model using the acquired learning data. Specifically, the learning unit 1300 extracts the feature amounts from the acquired images. Then, the learning unit 1300 learns a mapping function that converts the extracted feature amounts into auxiliary information. The mapping function may be not only the conversion from the image feature to the auxiliary information but also the conversion from the auxiliary information to the image feature.

For example, when the auxiliary information included in the acquired learning data is the distributed representation (word embedding), the learning unit 1300 learns a mapping function that converts the feature amount of the image into the distributed representation. Further, the learning unit 1300 may convert the label of the acquired data set into the distributed representation using a learned word2vec or the like, and may use the distributed representation for learning as the auxiliary information.

For example, when the auxiliary information included in the acquired learning data is an attribute, the learning unit 1300 learns a mapping function that converts the feature amount of the image into an attribute.

Also, the learning unit 1300 may use the learning method described in Non-Patent Document 1, for example.

The learning unit 1300 outputs the learned parameters of the model.

The above description is an explanation of an example in which the learning data includes an image, a label, and the auxiliary information. However, the learning data is not limited thereto. The learning data may include the feature amount of the image. Alternatively, the learning data may include the feature amount of the image instead of the image. When the learning data includes the feature amount of the image, the extraction of the feature amount can be omitted in the second selection unit 1200 and the learning unit 1300. Also, the learning data may include additional information, such as weights, calculated from the probability that each auxiliary information is observed.

In the learning data, plural labels may be associated with one image. Also, the label may be associated with the auxiliary information. Also, the label may be generated using the auxiliary information. For example, the label may be generated before being acquired by the first selection unit 1100 or the second selection unit 1200. The label may be generated by any of the first selection unit 1100, the second selection unit 1200, and the learning unit 1300.

In the learning data, plural auxiliary information may be associated with one image.

Also, the auxiliary information may be associated with the label. Also, the auxiliary information may be generated using either one or both of the image and the label. For example, the auxiliary information may be generated before being acquired by the first selection unit 1100 or the second selection unit 1200. The auxiliary information may be generated by any of the first selection unit 1100, the second selection unit 1200, and the learning unit 1300.

[Description of Operation]

FIG. 2 is a flowchart illustrating a flow of processing executed by the information processing system 1000 according to the first example embodiment.

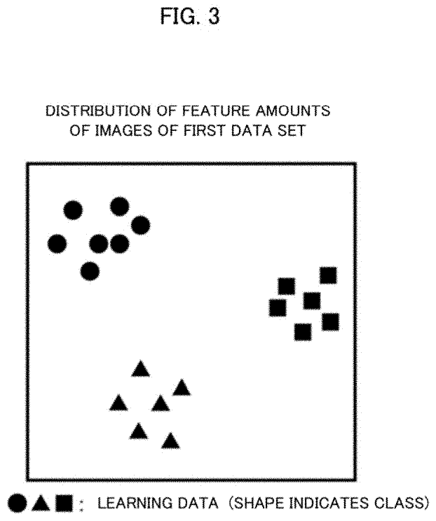

FIG. 3 is a diagram illustrating an example of a distribution of the feature amounts of the images of the first data set. The figures in FIG. 3 represent each learning data of the first data set, wherein the figures of the same shape belong to the same class. The images of the learning data belonging to the same class are similar in the feature amount of the image. Therefore, the learning data belonging to the same class are aggregated in the distribution. FIG. 3 represents the distribution of the feature amounts of the images of the learning data classified into three types of classes.

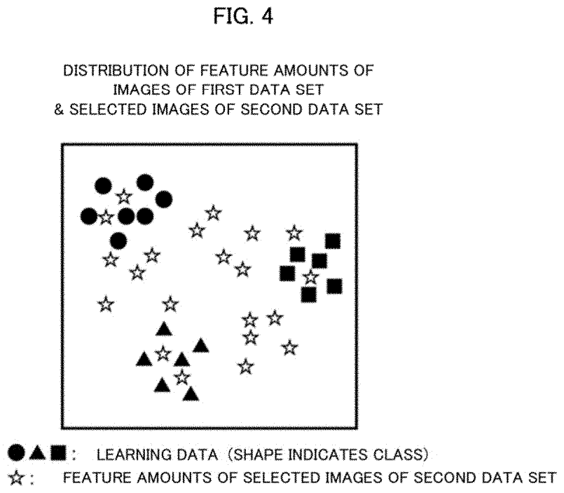

FIG. 4 is a diagram representing an example of a data set used for learning. The star-shaped figures in FIG. 4 represent the feature amounts of the images of the learning data of the second data set selected by the second selection unit 1200. Other figures in FIG. 4 represent the learning data of the first data set similar to FIG. 3. FIG. 4 represents the distribution of the data set used for learning in which the feature amounts of the images of the selected second data set are added to the distribution of the learning data of the first data set.

In step S101, the first selection unit 1100 acquires the first data set.

In step S102, the second selection unit 1200 acquires the second data set.

In step S103, the first selection unit 1100 selects two or more images from the first data set. The first selection unit 1100 outputs the two or more images selected. Incidentally, the order of steps S102 and S103 may be reversed.

In step S104, the second selection unit 1200 acquires the two or more images selected in step S103. The second selection unit 1200 selects an image from the second data set, based on the two or more images acquired. The second selection unit 1200 outputs the learning data corresponding to the selected image.

For example, in step S103, the first selection unit 1100 selects two images from the first data set distributed as shown in FIG. 3. In step S104, the second selection unit 1200 selects image located in the middle of the two selected images.

Steps S103 and S104 may be executed repeatedly a predetermined number of times. The repetitive processing of steps S103 and S104 may be terminated when a number of images selected from the second data set becomes equal to or greater than a threshold value. Further, the repetitive processing of steps S103 and S104 may be terminated when steps S103 and S104 are repeated a predetermined number of times. FIG. 4 represents a data set used for learning after the image is selected plural times from the second data set by the second selection unit 1200, wherein the feature amount of the image of the selected second data set is added plural times to the distribution of the learning data of the first data s

In step S105, the learning unit 1300 acquires the learning data of the first data set and the second data set corresponding to the images selected by the second selection unit 1200, and learns the model using the acquired learning data.

In step S106, the learning unit 1300 outputs the learned parameters of the model learned in step S105. After outputting the learned parameters, the information processing system 1000 ends the processing.

[Description of Effect]

The information processing system 1000 of the first example embodiment can solve the problem that the accuracy of the zero-shot recognition cannot be sufficiently obtained because the learning data includes few image data similar to the unknown image data. Namely, since the information processing system 1000 learns the model using the learning data to which images having the feature amount similar to the unknown image data with high possibility are added, it is possible to provide a model with high estimation accuracy of zero-shot recognition.

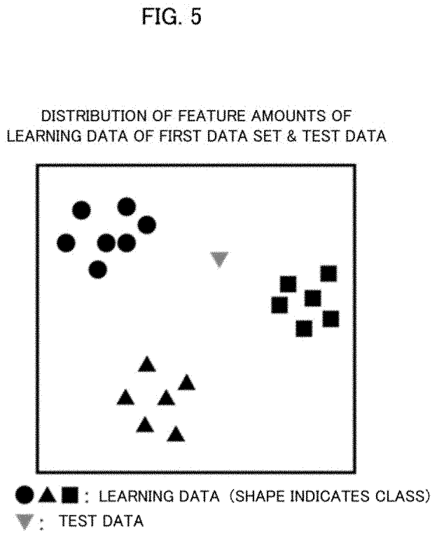

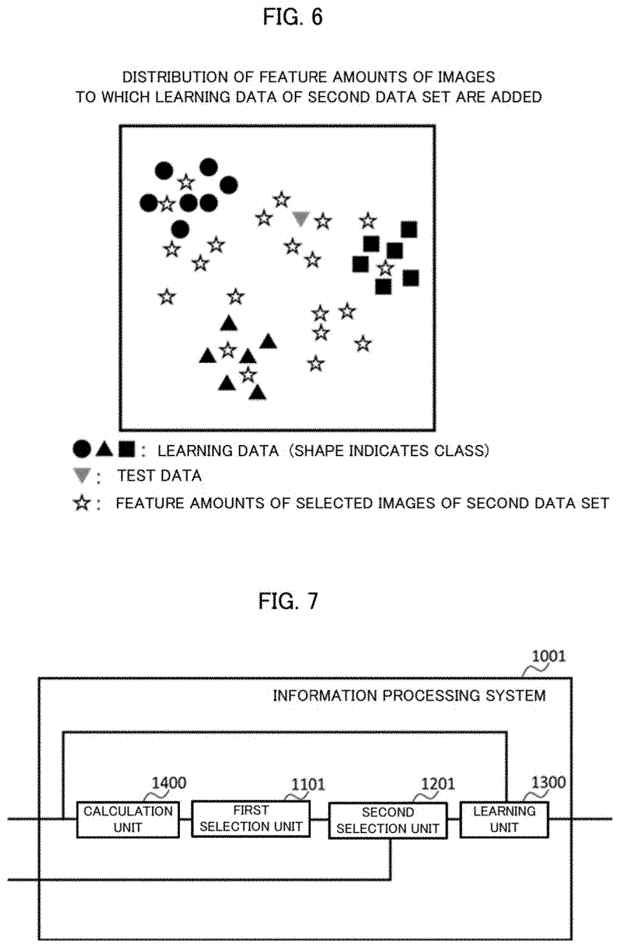

FIG. 5 is a diagram illustrating an example of learning data and test data when the first example embodiment is not applied, and FIG. 6 is a diagram illustrating an example of learning data and test data when the first example embodiment is applied. The inverse triangular figure in FIG. 5 represents the test data of the first data set. The other figures in FIG. 5 represent the learning data in the first data set, wherein the figures of the same shape belong to the same class. FIG. 5 represents the distribution of the feature amounts of the images of the learning data classified into three classes and the test data. The star-shaped figures in FIG. 6 represent the feature amounts of the images of the learning data of the second data set selected by the second selection unit 1200. The other figures in FIG. 6 represent the learning data of the first data set and test data similar to FIG. 5. FIG. 6 represents the distribution of the test data and the learning data when the first example embodiment is applied, wherein the feature amounts of the images of the selected second data set are added to the distribution of the learning data of the first data set. Since the second selection unit 1200 selects and adds the feature amounts of the images positioned in the middle of the feature amounts of the two or more images selected by the first selection unit 1100, the learning unit 1300 can learn the model using the learning data as shown in FIG. 6. FIG. 6 shows that the second selection unit 1200 has selected and added the images having the feature amount of the image distributed in the vicinity of the test data from the second data set. The learning unit 1300 can learn the model using the learning data in which the images having the feature amount similar to the test data are added. Namely, since the information processing system 1000 of the first example embodiment can perform recognition by the model that is learned using the images having the feature amounts similar to the feature amount of the image of the test data, it is possible to provide a model which can perform the zero-shot recognition of the test data with high accuracy.

When the first selection unit 1100 selects two or more images to which labels of different classes are associated, the first selection unit 1100 can avoid selecting two or more images from the same class. When the first selection unit 1100 selects the feature amounts of the two or more images to which the labels of the different classes are associated, the second selection unit 1200 selects the feature amount of the image located in the middle of the two or more images to which the labels of the different classes are associated. Therefore, the second selection unit 1200 can avoid selecting the feature amount of the image that is too similar to the feature amounts of the images of the learning data of the first data set. The second selection unit 1200 selects the feature amount of the image located in the middle of the two or more images, with which the labels of the different classes are associated and which are not too similar to the feature amount of the image of the learning data of the first data set. Therefore, the information processing system 1000 of the first example embodiment can increase the possibility of selecting the feature amount of the image similar to the test data and adding it to the learning data.

### Second Example Embodiment

### [Description of Configuration]

FIG. 7 is a diagram illustrating an example of a functional block of an information processing system 1001 according to a second example embodiment. The information processing system 1001 according to the second example embodiment includes a calculation unit 1400, a first selection unit 1101, a second selection unit 1201, and a learning unit 1300.

The calculation unit 1400 acquires the first data set including the learning data. For example, the learning data included in the first data set includes an image, a label, and auxiliary information. The label and the auxiliary information are associated with the image.

The calculation unit 1400 extracts the feature amounts of the acquired images. For example, the calculation unit 1400 can convert the image to the feature amount using the learned neural network.

The calculation unit 1400 calculates representative values of the images for each class of the labels from the images and the labels of the acquired first data set. For example, the calculation unit 1400 calculates the average value of the feature amounts of the acquired images as the representative value of the class to which the labels of the images belong. The method used to calculate the representative value is not limited to the calculation of the average value, and various statistics may be used. For example, the method used to calculate the representative value may use a statistical value such as a median value, a most frequent value, a standard deviation, or a variance.

The images used to calculate the representative value may be all images for each class, or may be some images arbitrarily selected. For example, the images used to calculate the representative value may be the images of a predetermined number for each label, randomly selected from the first data set.

The calculation unit 1400 outputs the calculated representative values.

The first selection unit 1101 acquires the representative values calculated by the calculation unit 1400.

The first selection unit 1101 arbitrarily selects two or more representative values from the acquired representative values. For example, the first selection unit 1101 may randomly select two or more representative values from the acquired representative values.

The first selection unit 1101 outputs the selected representative value.

The second selection unit 1201 acquires the representative values selected by the first selection unit 1101, and a second data set including the learning data that is different from the learning data included in the first data set.

The learning data included in the second data set includes an image, a label, and auxiliary information. The label and the auxiliary information are associated with the image.

The second selection unit 1201 selects an image from the second data set based on the representative values selected by the first selection unit 1101. Specifically, the second selection unit 1201 selects the image corresponding to the middle of the positions in the feature space of the two or more representative values selected by the first selection unit 1101, from the second data set. The second selection unit 1201 extracts the feature amount from the image included in the second data set. For example, the second selection unit 1201 can convert an image into a feature amount using the learned neural network.

The second selection unit 1201 calculates the weighted mean X_{new} of the two or more representative values selected by the first selection unit 1101 using Equation (1). Here, “wᵢ” in Equation (1) is a weight. “xᵢ” is the representative value. “n” is an integer of two or more sheets.

When two representative values are selected by the first selection unit 1101, the weighted mean X_{new} is calculated using Equation (2). Incidentally, “wᵢ” and “wⱼ” in the Equation (2) are the weights, and “xᵢ” and “xⱼ” are the representative values.

The weights used to calculate the weighted mean may be constants. For example, the weights may be the constants (wᵢ, wⱼ)=(0.4, 0.6). Alternatively, the weight may be a value generated using random numbers. For example, in the generation of the weights using random numbers, by using a beta distribution having a condition of α=β as a distribution of the random number generation, weighting is performed using a distribution symmetric with two data. In the generation of the weights using random numbers, by moving the value “α” as a hyperparameter, it is possible to express from a uniform distribution to a distribution choosing only one of them.

The second selection unit 1201 determines the similarity between the weighted mean X_{new}, and the feature amounts of the images of the second data set. Then, the second selection unit 1201 selects the images of the feature amount whose similarity degree is equal to or higher than the threshold value, from the second data set.

For example, the second selection unit 1201 uses the cosine similarity degree for the similarity determination between the weighted mean X_{new} and the feature amounts of the images of the second data set. The following explanation is directed to the case where the weighted mean X_{new} and the feature amounts of the images of the second data set are vectors. The second selection unit 1201 normalizes the two vectors such that the lengths of the two vectors become “1”, and obtains the inner product between the normalized vectors. The second selection unit 1201 determines that the weighted mean X_{new} and the feature amount of the image of the second data set are similar when the obtained inner product is equal to or greater than a predetermined value. The similarity determination is not limited to cosine similarity, and Euclidean distance, Mahalanobis distance, KL divergence, Earth mover's distance, or the like may be used.

The second selection unit 1201 outputs the learning data corresponding to the image selected from the second data set.

The function of the learning unit 1300 of the second example embodiment is the same as that of the learning unit 1300 of the first example embodiment.

The above description is an example in which the learning data includes an image, a label, and auxiliary information. However, the learning data is not limited thereto. The learning data may include the feature amount of the image. Alternatively, the learning data may include the feature amount of the image instead of the image. When the learning data includes the feature amount of the image, the extraction of the feature amount in the calculation unit 1400, the second selection unit 1201, and the learning unit 1300 may be omitted. Also, the learning data may include additional information, such as weights, calculated from the probability that each auxiliary information is observed.

In the learning data, plural labels may be associated with one image. Also, the label may be associated with the auxiliary information. The label may be generated using the auxiliary information. For example, the label may be generated before being acquired by the calculation unit 1400 or the second selection unit 1201. The label may be generated by any of the calculation unit 1400, the first selection unit 1101, the second selection unit 1201, and the learning unit 1300.

In the learning data, plural auxiliary information may be associated with one image. Also, the auxiliary information may be associated with the label. The auxiliary information may be generated using either one or both of the image and the label. For example, the auxiliary information may be generated before being acquired by the calculation unit 1400 or the second selection unit 1201. The auxiliary information may be generated by any of the calculation unit 1400, the first selection unit 1101, the second selection unit 1201, and the learning unit 1300.

[Description of Operation]

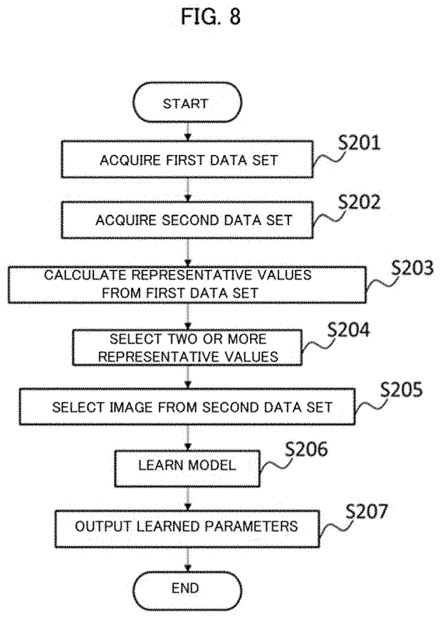

FIG. 8 is a flowchart illustrating a flow of processing executed by the information processing system 1001 of the second example embodiment.

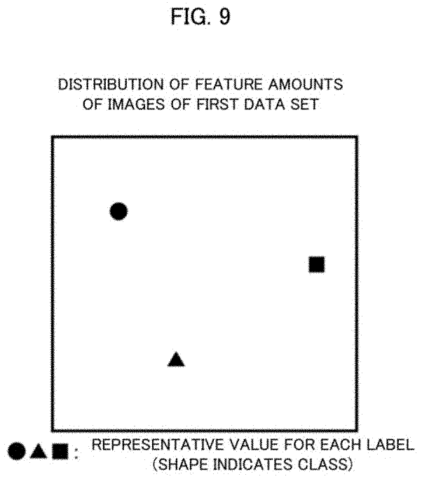

FIG. 9 is a diagram illustrating an example of the distribution of the representative values calculated from the first data set. The figures in FIG. 9 show the representative values of each class of the first data set, wherein the figure of different shape indicates different class. FIG. 9 shows the distribution of the representative values of the learning data classified into three types of classes.

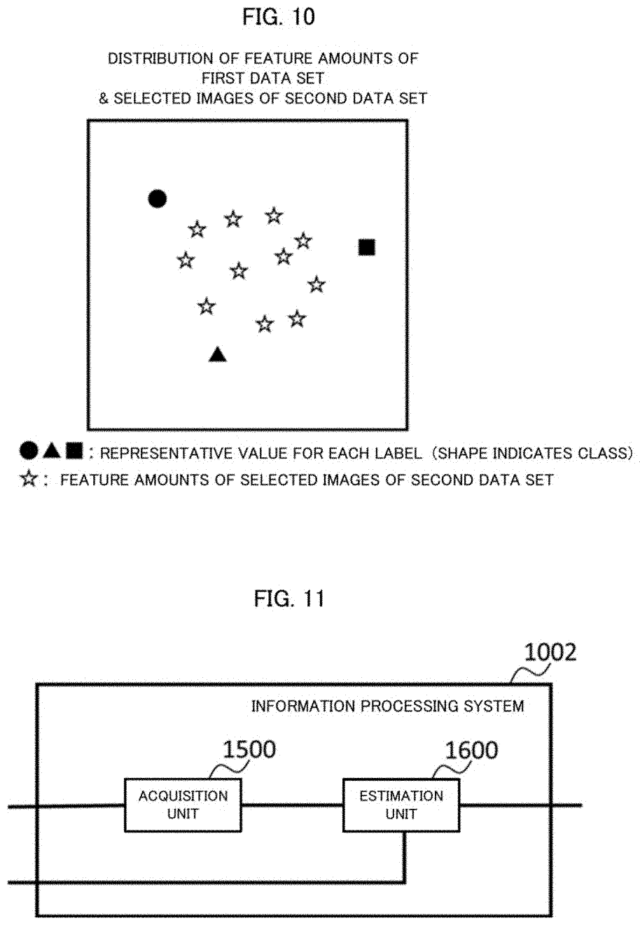

FIG. 10 is a diagram illustrating an example of the learning data selected from the second data set and used for learning. The star-shaped figures in FIG. 10 represent the feature amounts of the images of the learning data of the second data set selected by the second selection unit 1201. Other figures in FIG. 10 represent the representative values of each class of the first data set similar to FIG. 9. FIG. 10 shows the distribution of data sets used for learning, wherein the feature amounts of the images of the selected second data set are added to the distribution of the representative values of each class of the first data set.

In step S201, the calculation unit 1400 acquires the first data set.

In step S202, the second selection unit 1201 acquires the second data set.

In step S203, the calculation unit 1400 calculates the representative values from the acquired first data set. The calculation unit 1400 outputs the calculated representative values. Incidentally, the order of steps S202 and S203 may be reversed.

In step S204, the first selection unit 1101 acquires the representative values from the calculation unit 1400, and selects two or more representative values from the acquired representative values. The first selection unit 1101 outputs the two or more representative values selected. Step S202 may be executed between steps S204 and S205.

In step S205, the second selection unit 1201 acquires the two or more representative values selected in step S204. The second selection unit 1201 selects an image from the second data set based on the two or more representative values obtained. The second selection unit 1201 outputs the learning data corresponding to the selected image.

For example, in step S204, the first selection unit 1101 selects two representative values from the representative values of the first data set distributed as shown in FIG. 9. In step S205, the second selection unit 1201 selects an image located in the middle of the two selected representative values.

Steps S204 and S205 may be executed repeatedly a predetermined number of times. The repetitive processing of steps S204 and S205 may be terminated when the images of a number equal to or greater than a threshold value are selected from the second data set. Also, the repetitive processing of steps S204 and S205 may be terminated when steps S204 and S205 are repeated a predetermined number of times. FIG. 10 shows a data set after the images are selected a plurality of times from the second data set by the second selection unit 1201, wherein the feature amounts of the images of the selected second data set are added plural times to the distribution of the representative values of the first data set. The learning data of the first data set and the second data set corresponding to the images selected by the selections of the plural times are used for learning.

In step S206, the learning unit 1300 acquires the learning data of the first data set and the second data set corresponding to the images selected by the second selection unit 1201, and learns the model using the acquired learning data.

In step S207, the learning unit 1300 outputs the learned parameters of the model learned in step S206. After outputting the learned parameters, the information processing system 1001 ends the processing.

[Description of Effect]

The information processing system 1001 of the second example embodiment can solve the problem that the accuracy of the zero-shot recognition cannot be sufficiently obtained because the learning data includes few image data similar to the unknown image data. Namely, since the information processing system 1001 learns the model using the learning data to which images having the feature amount similar to the unknown image data with high possibility are added, it is possible to provide a model with high estimation accuracy of zero-shot recognition.

In the information processing system 1001 of the second example embodiment, even when the first data set includes a large number of images, since the large number of images are converted into the representative values for each label, repetitive processing can be efficiently performed. Therefore, the information processing system 1001 can reduce the calculation time. Further, since the information processing system 1001 selects an image located in the middle of the representative value for each label, it is possible to efficiently add the images having the feature amounts similar to the test data without adding the images too similar to the learning data. Therefore, the information processing system 1001 can increase the possibility of selecting the feature amounts of the images similar to the test data and adding them to the learning data.

### Third Example Embodiment

### [Description of Configuration]

FIG. 11 is a diagram illustrating an example of a functional block of the information processing system 1002 according to a third example embodiment. The information processing system 1002 according to the third example embodiment includes an acquisition unit 1500 and an estimation unit 1600.

The acquisition unit 1500 acquires an image to be estimated.

The acquisition unit 1500 outputs the acquired image.

The estimation unit 1600 estimates the label corresponding to the auxiliary information most similar to the auxiliary information converted from the image acquired by the acquisition unit 1500 using a model. The model is learned using the first data set, and the learning data of the second data set corresponding to the images selected from the second data set based on the positions in the feature space of two or more images of the first data set. For example, the learned model used by the estimation unit 1600 is a model learned in the first example embodiment or the second example embodiment. Further, the estimation unit 1600 may hold or acquire the correct label of the object to be estimated.

For example, when the model learned using the distributed representation (word embedding) is used for the auxiliary information, the estimation unit 1600 converts the image acquired by the acquisition unit 1500 into the distributed representation using the learned model. The estimation unit 1600 determines a correct label having the distributed representation most similar to the converted distributed representation from the stored or acquired correct label, and sets it as an estimation result. The estimation unit 1600 may convert the correct label into the distributed representation using learned word2vec or the like, and use it to determine the correct label having the most similar distributed representation. Further, the estimation unit 1600 may output the converted distributed representation as the estimation result.

For example, when using the attribute as the auxiliary information, the estimation unit 1600 converts the image acquired by the acquisition unit 1500 into the attribute using the learned model. The estimation unit 1600 determines the correct label to which the attribute most similar to the converted attribute is associated, from the stored or acquired correct label, and determines the correct label as the estimation result. Further, the estimation unit 1600 may output the converted attribute as the estimation result.

When determining the most similar auxiliary information, the estimation unit 1600 may use cosine similarity, Euclidean distance, Mahalanobis distance, KL divergence, Earth mover's distance, or the like, for example.

The estimating unit 1600 outputs the estimation result.

[Description of Operation]

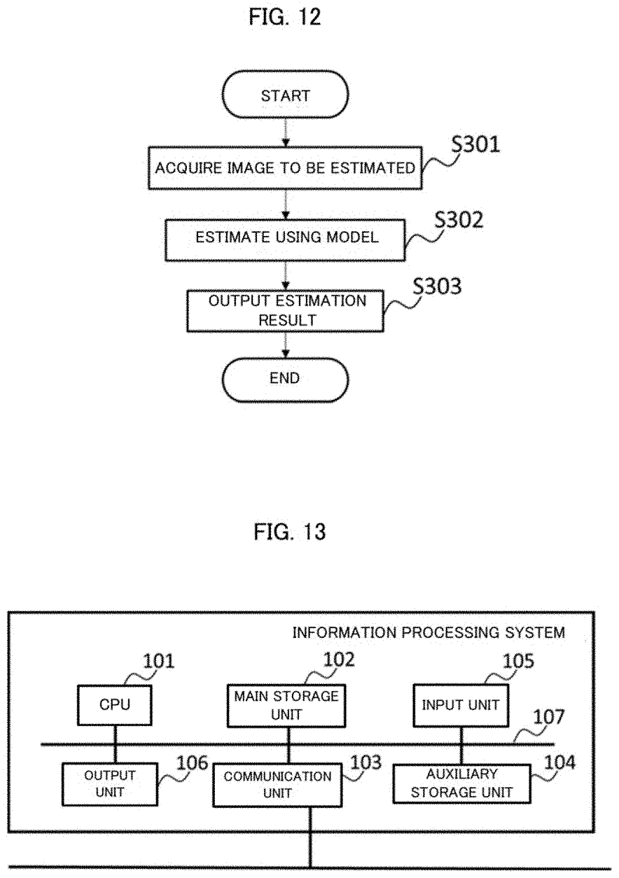

FIG. 12 is a flowchart illustrating a flow of processing executed by the information processing system 1002 according to the third example embodiment.

In step S301, the acquisition unit 1500 acquires the image to be estimated. The acquisition unit 1500 outputs the acquired image.

In step S302, the estimation unit 1600 acquires the image from the acquisition unit 1500, and estimates the image using the learned model.

In step 303, the estimation unit 1600 outputs the estimation result. After outputting the estimation result, the information processing system 1002 ends the processing.

[Description of Effect]

The information processing system 1002 of the third example embodiment can solve the problem that the accuracy of the zero-shot recognition cannot be sufficiently obtained because the learning data includes few image data similar to the unknown image data. Namely, since the information processing system 1002 learns the model using the learning data to which images having the feature amount similar to the test data are added, it is possible to perform zero-shot recognition with high estimation accuracy.

<Hardware Configuration>

The following description is a specific example of the hardware configuration of the information processing system 1000, the information processing system 1001, and the information processing system 1002 of the example embodiments. FIG. 13 is an explanatory diagram illustrating a hardware configuration example of the information processing systems according to the example embodiments.

The information processing system shown in FIG. 13 includes a CPU (Central Processing Unit) 101, a main storage unit 102, a communication unit 103, and an auxiliary storage unit 104. Further, the information processing system illustrated in FIG. 13 may include an input unit 105 for the user to operate, and an output unit 106 for presenting the processing result or the progress of the processing contents to the user.

The main storage unit 102 is used as a work area or a temporary evacuation area of the data. The main storage unit 102 is, for example, a RAM (Random Access Memory).

The communication unit 103 has a function of inputting and outputting data to and from peripheral devices via a wired network or a wireless network (information communication network).

The auxiliary storage unit 104 is a non-transitory tangible storage medium. The non-transitory tangible storage media include, for example, a magnetic disk, a magnetic-optical disk, a CD-ROM (Compact Disk Read Only Memory), a DVD-ROM (Digital Versatile Disk Read Only Memory), and a semiconductor memory.

The input unit 105 has a function of inputting data and processing instructions. The input unit 105 is an input device such as a keyboard or a mouse, for example.

The output unit 106 has a function of outputting data. The output unit 106 is, for example, a display device such as a liquid crystal display device, or a printing device such as a printer.

Also, as shown in FIG. 13, each component is connected to the system bus 107.

The auxiliary storage unit 104 stores, for example, a program for realizing the first selection unit 1100, the first selection unit 1101, the second selection unit 1200, the second selection unit 1201, the learning unit 1300, the calculation unit 1400, the acquisition unit 1500, and the estimation unit 1600.

Further, the first selection unit 1100, the first selection unit 1101, the second selection unit 1200, the second selection unit 1201 and the acquisition unit 1500 may receive a data set, an image or the like via the communication unit 103. Further, the estimation unit 1600 may transmit the estimation result via the communication unit 103.

The information processing system 1000, the information processing system 1001, and the information processing system 1002 may be realized by hardware. For example, the information processing system 1000 may be implemented by a circuitry including hardware components such as LSIs (Large Scale Integration) in which a program for realizing the functions as shown in FIG. 1 is incorporated.

Further, the information processing system 1000, the information processing system 1001 and the information processing system 1002 may be implemented by software such that the CPU 101 shown in FIG. 13 executes a program that provides the functions of the components shown in FIG. 1, 7 or 11.

When the information processing system 1000, the information processing system 1001 and the information processing system 1002 are implemented by software, the CPU 101 loads the program stored in the auxiliary storage unit 104 into the main storage unit 102 and executes the program to control the operation of the information processing system 1000, the information processing system 1001 or the information processing system 1002, thereby realizing each function by software.

Also, some or all of the components may be implemented by general-purpose circuitry or dedicated circuitry, processors, or the like, or combinations thereof. They may be composed of a single chip or a plurality of chips connected via a bus. Some or all of the components may be implemented by a combination of a program with circuitry or the like described above.

When a part or all of each component is realized by a plurality of information processing devices and circuits or the like, the plurality of information processing devices and circuits or the like may be centrally arranged, or may be dispersed. For example, the information processing device, the circuit, or the like may be implemented as a form in which each is connected through a communication network, such as a client and server system, a cloud computing system, or the like.

Each of the above-described example embodiments and specific examples can be appropriately combined and implemented.

The block division shown in each block diagram is a configuration represented for convenience of explanation. The present invention described with reference to the example embodiments as an example is not limited to the configuration shown in each block diagram in its implementation.

Further, the drawing reference numerals described above are for convenience to each element as an example for helping understanding, it is not intended to limit the present invention to the illustrated aspect.

While the above description has been given of embodiments for carrying out the present invention, the above example embodiments are intended to facilitate understanding of the present invention and are not intended to limit the present invention. The present invention may be modified and improved without departing from the spirit thereof, and equivalents thereof are also included in the present invention.

A part or all of the example embodiments described above may also be described as the following supplementary notes, but not limited thereto.

(Supplementary Note 1)

An information processing system comprising:

a first selection means for selecting two or more images from a first data set that includes learning data including an image, a label associated with the image, and auxiliary information;

a second selection means for selecting an image from a second data set including learning data different from the learning data included in the first data set, based on positions in a feature space of the two or more images selected by the first selection means; and

a learning means for learning a model for estimating a label based on the auxiliary information using the learning data included in the first data set and the learning data corresponding to the image selected by the second selection means.

(Supplementary Note 2)

The information processing system according to supplementary note 1,

wherein the auxiliary information is distributed representation of a word indicated by the label associated with the image, and

wherein the learning means learns the model for estimating the label based on the distributed representation.

(Supplementary Note 3)

The information processing system according to supplementary note 1,

wherein the auxiliary information is an attribute representing a characteristic of an object indicated by the image, and

wherein the learning means learns the model for estimating the label based on the attribute.

(Supplementary Note 4)

The information processing system according to any one of supplementary notes 1 to 3, wherein the second selecting means selects, from the second data set, an image corresponding to a middle of the positions in the feature space of the two or more images selected by the first selecting means.

(Supplementary Note 5)

The information processing system according to supplementary note 4, wherein the second selection means selects, from the second data set, an image corresponding to a feature amount similar to a weighted mean of feature amounts of the two or more images selected by the first selection means.

(Supplementary Note 6)

The information processing system according to supplementary note 5, wherein the second selection means selects, from the second data set, an image corresponding to a feature amount whose similarity to a weighted mean of the feature amounts of the two or more images selected by the first selection means exceeds a threshold value.

(Supplementary Note 7)

An information processing system comprising:

a calculation means for calculating representative values of images for each label, from the images and the labels associated with the images of a first data set that includes learning data including the image, the label associated with the image and auxiliary information;

a first selecting means for selecting two or more representative values from the representative values;

a second selection means for selecting an image from a second data set including learning data different from the learning data included in the first data set, based on positions in a feature space of the two or more representative values; and

a learning means for learning a model for estimating the label based on the auxiliary information using the learning data included in the first data set and the learning data corresponding to the image selected by the second selection means.

(Supplementary Note 8)

An information processing system comprising:

an acquisition means for acquiring an image; and

an estimation means for estimating a label corresponding to auxiliary information most similar to the auxiliary information converted from the image acquired by the acquisition means using a model learned using learning data of a first data set and learning data of a second data set, wherein the learning data of the first data set includes an image, a label associated with the image and auxiliary information, and wherein the learning data of the second data set corresponds to the image selected from the second data set, including the learning data different from the learning data included in the first data set, based on positions in a feature space of two or more images of the first data set.

(Supplementary Note 9)

An information processing method comprising:

selecting two or more images from a first data set that includes learning data including an image, a label associated with the image, and auxiliary information;

selecting an image from a second data set including the learning data different from the learning data included in the first data set, based on positions in a feature space of the two or more images selected from the first data set; and

learning a model for estimating a label based on the auxiliary information using the learning data included in the first data set and the learning data corresponding to the image selected from the second data set.

(Supplementary Note 10)

A recording medium storing a program for causing a computer to execute:

a first selection process for selecting two or more images from a first data set that includes learning data including an image, a label associated with the image, and auxiliary information;

a second selection process for selecting an image from a second data set including learning data different from the learning data included in the first data set, based on positions in a feature space of the two or more images selected by the first selection process; and

a learning process for learning a model for estimating a label based on the auxiliary information using the learning data included in the first data set and the learning data corresponding to the image selected by the second selection process.

While the present invention has been described with reference to the example embodiments and examples, the present invention is not limited to the above example embodiments and examples. Various changes which can be understood by those skilled in the art within the scope of the present invention can be made in the configuration and details of the present invention.

### INDUSTRIAL APPLICABILITY

The present invention can be applied to machine learning when some labels do not have learning data. For example, according to the present invention, in the defective detection of the target product in the production line of the factory, even when there is no image example of the defective product of the target product, by preparing and learning the learning data obtained by adding images similar to the defective product of the target product, it becomes possible to perform high-precision zero-shot recognition in defective product detection of the target product.

Further, the present invention is one of transfer learning, and can be applied not only to zero-shot learning by using the present invention, but also to uses such as improving accuracy by complementing with large-scale data when data with images for learning is small or biased. Also, the present invention can be applied to the uses such as searching an image closest to a combination of a plurality of images in searching similar images.

### DESCRIPTION OF SYMBOLS

101 CPU
102 Main storage unit
103 Communication unit
104 Auxiliary storage unit
105 Input unit
106 Output unit
107 System bus
1000, 1001, 1002 Information processing system
1100, 1101 First selection unit
1200, 1201 Second selection unit
1300 Learning unit
1400 Calculation unit
1500 Acquisition unit
1600 Estimation unit

What is claimed is:

1. An information processing system comprising a processor configured to:
select two or more images from a first data set that includes learning data including an image, a label associated with the image, and supplementary information;
select an image from a second data set including learning data different from the learning data included in the first data set, based on positions in a feature space of the two or more images selected; and
learn a model for estimating a label based on the supplementary information using the learning data included in the first data set and the learning data corresponding to the image selected.

2. The information processing system according to claim 1,
wherein the supplementary information is distributed representation of a word indicated by the label associated with the image, and
wherein the processor learns the model for estimating the label based on the distributed representation.

3. The information processing system according to claim 1,
wherein the supplementary information is an attribute representing a characteristic of an object indicated by the image, and
wherein the processor learns the model for estimating the label based on the attribute.

4. The information processing system according to claim 1, wherein the processor selects, from the second data set, an image corresponding to a middle of the positions in the feature space of the two or more images selected.

5. The information processing system according to claim 4, wherein the processor selects, from the second data set, an image corresponding to a feature amount similar to a weighted mean of feature amounts of the two or more images selected.

6. The information processing system according to claim 5, wherein the processor selects, from the second data set, an image corresponding to a feature amount whose similarity to a weighted mean of the feature amounts of the two or more images selected exceeds a threshold value.

7. An information processing system comprising a processor configured to:
calculate representative values of images for each label, from the images and the labels associated with the images of a first data set that includes learning data including the image, the label associated with the image and supplementary information;
select two or more representative values from the representative values;
select an image from a second data set including learning data different from the learning data included in the first data set, based on positions in a feature space of the two or more representative values; and
learn a model for estimating the label based on the supplementary information using the learning data included in the first data set and the learning data corresponding to the image selected.

8. An information processing system comprising a processor configured to:
acquire an image; and
estimate a label corresponding to supplementary information most similar to the supplementary information converted from the image acquired using a model learned using learning data of a first data set and learning data of a second data set, wherein the learning data of the first data set includes an image, a label associated with the image and supplementary information, and wherein the learning data of the second data set corresponds to the image selected from the second data set, including the learning data different from the learning data included in the first data set, based on positions in a feature space of two or more images of the first data set.

9. An information processing method comprising:
selecting two or more images from a first data set that includes learning data including an image, a label associated with the image, and supplementary information;
selecting an image from a second data set including the learning data different from the learning data included in the first data set, based on positions in a feature space of the two or more images selected from the first data set; and
learning a model for estimating a label based on the supplementary information using the learning data included in the first data set and the learning data corresponding to the image selected from the second data set.

10. A non-transitory computer-readable recording medium storing a program for causing a computer to:
select two or more images from a first data set that includes learning data including an image, a label associated with the image, and supplementary information;
select an image from a second data set including learning data different from the learning data included in the first data set, based on positions in a feature space of the two or more images selected; and
learn a model for estimating a label based on the supplementary information using the learning data included in the first data set and the learning data corresponding to the image selected.
